(19) United States
(12) Patent Application Publication
(10) Pub. No.: US 2017/0017511 A1
(43) Pub. Date: Jan. 19, 2017

(54) METHOD FOR MEMORY MANAGEMENT IN VIRTUAL MACHINES, AND CORRESPONDING SYSTEM AND COMPUTER PROGRAM PRODUCT

(71) Applicant: ECO4CLOUD S.r.l., Rende (CS) (IT)

(72) Inventors: Giuseppe PAPUZZO, Rende (CS) (IT); Raffaele GIORDANELLI, Rende (CS) (IT); Giovanni LUPI, Rende (CS) (IT); Carlo MASTROIANNI, Rende (CS) (IT); Agostino FORESTIERO, Rende (CS) (IT)

(21) Appl. No.: 15/124,274

(22) PCT Filed: Mar. 5, 2015
(86) PCT No.: PCT/IB2015/051617

§ 371 Date: Sep. 7, 2016

(30) Foreign Application Priority Data
Mar. 7, 2014 (IT) TO2014A000183

(51) Int. Cl. G06F 9/455; G06F 12/02; G06F 9/50

(52) U.S. Cl. CPC G06F 9/45558; G06F 9/5016; G06F 12/023; G06F 2009/45583; G06F 2212/1044

(57) ABSTRACT

A method for memory management includes in a virtual-machine monitor of a virtualization platform allocating in a guest operating system of the virtual machines guest balloon memory modules of variable memory size. Memory parameters of a given virtual machine are read. A value of a configured limit, set in the virtual-machine monitor, for the consumed memory is read. The value represents a threshold beyond which allocation of memory to the guest balloon memory module is to be performed. The threshold value is shifted from the configured limit to a lower value. A start of ballooning operations is waited for by the virtual-machine monitor. It is checked when said ballooning operations terminate. The threshold is set beyond which allocation of memory is to be performed back to the configured limit value.

### TECHNICAL FIELD

The present disclosure relates to techniques for memory management in virtual machines, which comprises the operations of providing, in a virtual-machine monitor of a virtualization platform that operates on one or more host computers, a memory-management procedure that includes ballooning operations, which comprise allocating, in a guest operating system of said virtual machines, guest balloon memory modules of variable memory size which have a given target size, said target size of the guest balloon memory modules being controlled as a function of the amount of memory of the host consumed by the virtual machines.

Various embodiments may be applied to memory management in data centres that comprise pluralities of servers and terminals, in particular arranged in sets of servers, or also in single host computers.

### TECHNOLOGICAL BACKGROUND

In the computer and information-technology sector virtualization techniques are known, which make available to the software usually hardware processor components in the form of virtual resource. The above virtual hardware can be used for installing entire operating systems and applications. The ensemble of the virtual hardware components, such as hard disks, RAM, CPU, etc., takes the name of “virtual machine”. Virtual machines can be generated both on desktop systems and on server systems.

Illustrated in FIG. 1 is a simple scheme of the levels of a classic architecture of a virtual machine.

A physical machine 10, such as for example a processor, which operates as host machine, is associated to a software layer, referred to as “virtual-machine monitor” or also “hypervisor”, 11, which carries out control of the hardware of the machine and creates virtual machines 13. Each of these virtual machines 13 behaves like a physical machine, which can execute an operating system 14 of its own, also referred to as “guest operating system”, and applications 15 of its own within the above operating system 14.

A virtualization platform that is well known for carrying out the aforesaid functions and that is widely used is represented by the VMware platform of VMware Inc., within which, for example, the hypervisor vSphere ESXi may be mentioned, which represents an virtualization operating system for cloud computing. Another example of the above platform is constituted by the Linux virtualization infrastructure Kernel-based Virtual Machine (KVM).

Illustrated in FIG. 2 is the architecture of a data centre 20, which can implement, for example, the above virtualization system, in particular vSphere. It may be envisage, connected via data communication networks 21, for example Ethernet, arrays of servers 22, in particular ×86 servers, divided into sets of servers 23a, 23b, 23c. A network of an IP (Internet Protocol) type 24 enables connection of the sets of servers 23 with storage units 25, for example of an SCSI type, an NAS type, etc. Represented as connected on the data-communication network 21 are specific servers and terminals, such as a server 26, for the software vCenter of VMware that provides a control point for the data centre 20, a host 27 for executing the client of the virtual-machine monitor, or hypervisor, vSphere, a web terminal 28, and a generic terminal 29.

Each server 22 can be defined as autonomous host computer in the virtual environment, like the host computer 10 of FIG. 1, and can execute a plurality of virtual machines 13. Servers 22 configured in a similar way and connected to the same networks 21, 24 and to the same storage systems 25 can be grouped together to provide an aggregate of resources in the virtual environment, referred to as “cluster”.

The VMware client vSphere virtualizes computer structures, such as that of FIG. 1, including the servers, the storage units, and the networks, aggregating the resources and presenting a uniform ensemble of elements in the virtual environment, enabling management of the resources as a shared utility, and providing resources in a dynamic way to the different business units and projects.

In the above field, memory-management techniques are implemented for calculating target values of memory allocation for each virtual machine on the basis of the load of the system and of the setting of specific parameters of the virtual machine.

For this purpose, in virtualization platforms such as VMware, and in particular in the virtualization operating system for cloud computing vSphere, a mechanism, referred to as “ballooning”, is implemented, which enables freeing of memory of the host that is consumed by the virtual machines, i.e., consumed memory.

FIG. 10 shows a virtualization system with a ballooning function. A virtual machine 13 is installed on a host 10, which comprises system hardware 42 and layers or components, amongst which the host operating system and the virtual-machine monitor or hypervisor 14. The system hardware may comprise one or more CPUs, memory-management units, forms of volatile or nonvolatile memory, and storage devices, such as hard disks and separable storage devices. The virtual machine 13 replicates virtually the structure of a physical computer, and hence comprises a virtual system hardware 34 and a guest system software, which comprises the guest operating system 14 and the necessary drivers, amongst which a balloon driver 32, for implementing the communications between a ballooning application 48 and a scheduler of the resources 40 in a kernel 38 of the host 10. This scheduler may also be distributed between the virtual-machine monitor 11 and the virtualization kernel 38. It determines the target, for example of the memory target, of the virtual machine 13. Designated by 15 are the applications run on the guest operating system 14. The virtual-machine monitor 11 and the virtualization kernel 38 constitute a virtualization platform or layer that operates as interface between the guest software of the virtual machine and the underlying hardware platform. In general, even though not illustrated, the host 10 may have a number of virtual machines 13, associated to which is a respective instance of the virtual-machine monitor 11.

The ballooning application 48 is run as guest application on the virtual machine 13, typically in a non-privileged way, and the guest operating system 14 includes the balloon driver 32, which is run as device driver in the guest operating system 14 and can carry out privileged operations, such as reserving guest physical memory. The balloon driver 32 exchanges messages with the ballooning application 48.

The resource scheduler 40 in the kernel 38 manages assignment of the resources to the virtual machines 13, such as the machine memory (see also FIG. 9a), determining how much machine memory is to be allocated to a given virtual machine 13. If the scheduler 40 determines that the amount of memory allocated to the virtual machine must be regulated, it can reclaim memory, using various methods, such as paging out of machine memory mapped in the guest physical memory of the virtual machine 13 onto another device. In particular, the scheduler 40 can reclaim machine memory using the ballooning application 48 for reducing the amount of guest physical memory used by the applications 15. The ballooning application 48 may in particular detect a request for increasing or decreasing a memory module of variable size, the balloon, i.e., the amount of balloon memory B, via the balloon driver.

The ballooning technique hence takes into account the fact that, when a hypervisor needs to reclaim memory from the virtual machines, given that the virtual machines are isolated, their guest operating system is not aware of the state of the other virtual machines on the same host. Furthermore, when the guest operating system allocates memory, this is also allocated at the host level. When, instead, the operating system frees memory, this memory, which is now free, is not released to the host, and this generates unnecessary consumption of memory. When the hypervisor runs multiple virtual machines and the amount of free host memory becomes low, none of the virtual machines will free guest physical memory in so far as the guest operating system cannot detect shortage of the host memory. The ballooning technique substantially makes the guest operating system aware that the level of memory of the host is low. For this purpose, into the guest operating system the specific balloon driver is loaded, which controls the size allocated for the amount of memory, referred to as “balloon”, of the guest operating system. The balloon driver has no interface and communicates with the hypervisor through a dedicated channel. The balloon driver reclaims, in the framework of a polling sequence, a target balloon size. If the hypervisor needs to reclaim virtual-machine memory, it sets an adequate target balloon size, inflating the balloon via allocation of physical guest pages within the virtual machine.

In other words:
the balloon driver 32 contacts the hypervisor or virtual-machine monitor 11 at regular intervals to obtain the balloon size B;
if the hypervisor 11 is in need of memory, it sets a target size for the balloon driver 32, getting it to “inflate” via allocation of guest physical memory within the given virtual machine 13;
the balloon driver 32 allocates the memory requested by “locking it”, i.e., by setting it in such a way that it cannot be swapped on the disk via the mechanisms of the guest operating system;
once the balloon memory B has been allocated, the balloon driver 32 communicates to the hypervisor 11 which pages it has allocated so that the hypervisor 11 can then recover them;
when the hypervisor 11 decides to “deflate” the balloon driver 32, setting a smaller target size for it, the balloon driver 32 de-allocates the pages that it had reserved.

The above ballooning mechanism, already described also with reference to FIG. 10 is in any case in itself known, and a more detailed description thereof is available in the document at the URL http://www.vmware.com/files/pdf/perf-vsphere-memory management.pdf, in particular in Section 3.3, page 8.

Through the above technique it is hence possible to free memory “unused” by the virtual machines and make it available for the virtual-machine monitor (vSphere), i.e., the hypervisor, which will possibly allocate it to other virtual machines of the data centre.

A virtual-machine monitoring system, such as for example VMware vSphere normally allocates for the virtual machine the memory pages reclaimed. However, the mechanism of release of the memory pages that the virtual machine no longer uses is not efficient. To recover memory pages from the virtual machine, for example, VMware waits for use of the host machine memory, i.e., the memory consumed, to exceed a given value, identified by a configured limit, in particular 94%.

In addition, a further drawback is represented by the fact that it is impossible to predict which virtual machines will be required to free memory via the ballooning mechanism.

### OBJECT AND SUMMARY

The object of the embodiments described herein is to improve the methods and systems according to the known art, as discussed previously.

Various embodiments achieve the above object thanks to a method having the characteristics recalled in the ensuing claims. Various embodiments may also refer to corresponding processing systems, as well as to a computer program product that can be loaded in the memory of at least one computer (e.g., a terminal in a network) and comprises portions of software code that are able to implement the steps of the method when the program is run on at least one computer. As used herein, the aforesaid computer program product is understood as being equivalent to a computer-readable means containing instructions for controlling the computer system so as to co-ordinate implementation of the method according to the invention. Reference to “at least one computer” is understood as emphasizing the possibility of the present invention being implemented in a modular and/or distributed form. The claims form an integral part of the technical teachings provided herein in relation to the invention.

### BRIEF DESCRIPTION OF THE DRAWINGS

Various embodiments will now be described, purely by way of example, with reference to the annexed drawings, wherein:

FIGS. 1, 2, and 10 have already been described previously;

FIG. 3 shows a flowchart representing an embodiment of the method according to the invention;

FIG. 4 shows a block diagram of the software architecture that implements method according to the invention;

FIG. 5 shows a diagram of software classes used for implementing the method according to the invention;

FIG. 6 shows a diagram representing a sequence of operations implemented by the method of according to the invention;

FIG. 7 shows a flowchart of operations of the method according to the invention performed by a first software object implementing the method according to the invention;

FIG. 8 shows a flowchart of operations of the method according to the invention performed by a second software object implementing the method according to the invention; and

FIGS. 9a, 9b, 9c illustrate an interface of a virtual-machine monitor in three operating conditions according to the method of the invention.

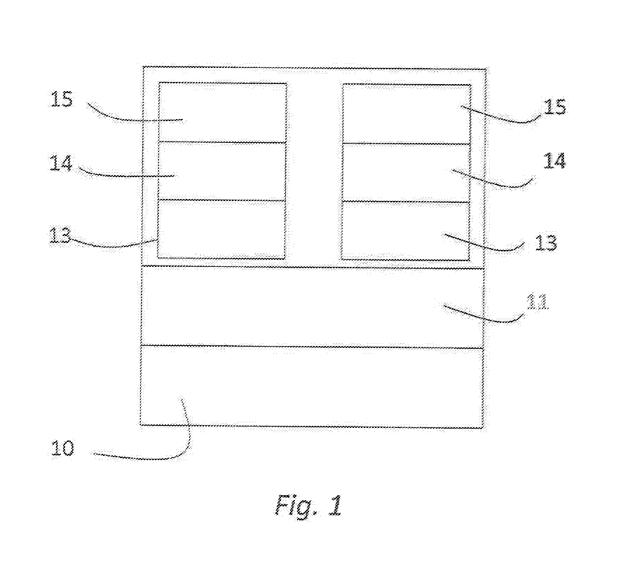

### DETAILED DESCRIPTION

In the ensuing description, various specific details are provided in order to enable maximum understanding of the embodiments provided by way of example. The embodiments may be implemented with or without specific details, or else with other methods, components, materials, etc. In other circumstances, structures, materials, or operations that are well known are not illustrated or described in detail so that aspects of the embodiments will not be obscured. Reference in the course of the present description to “an embodiment” or “one embodiment” means that a particular detail, structure, or characteristic described in connection with the embodiment is comprised in at least one embodiment. Hence, phrases such as “in an embodiment” or “in one embodiment” or the like that may be present in various points of the present description do not necessarily refer to one and the same embodiment. Furthermore, the particular details, structures, or characteristics may be combined in any convenient way in one or more embodiments.

The wordings and references are provided herein merely for convenience of the reader and do not define the scope or the meaning of the embodiments.

As has been mentioned, virtual-machine monitors of virtualization systems, such as for example VMware vSphere, possess a ballooning mechanism for freeing memory that is “unused” by the virtual machines and make it available for managing the virtual-machine monitor.

The method according to the invention basically envisages, in the case where a given set of conditions for its applicability, i.e., for enabling its execution, carrying out operations that force a virtual-machine monitor of this sort to start the above ballooning allocation mechanism and hence free unused memory.

The above conditions of applicability comprise both static and dynamic constraints:
the constraints of a static type are represented by those conditions that a virtual machine must respect to make possible application thereon, i.e., enabling, of the operations of forcing of ballooning envisaged by the method according to the invention;
during execution of the method also other parameters are continuously monitored that hence define conditions, or constraints of a dynamic type, that must be respected for the method according to the invention to continue to operate properly.

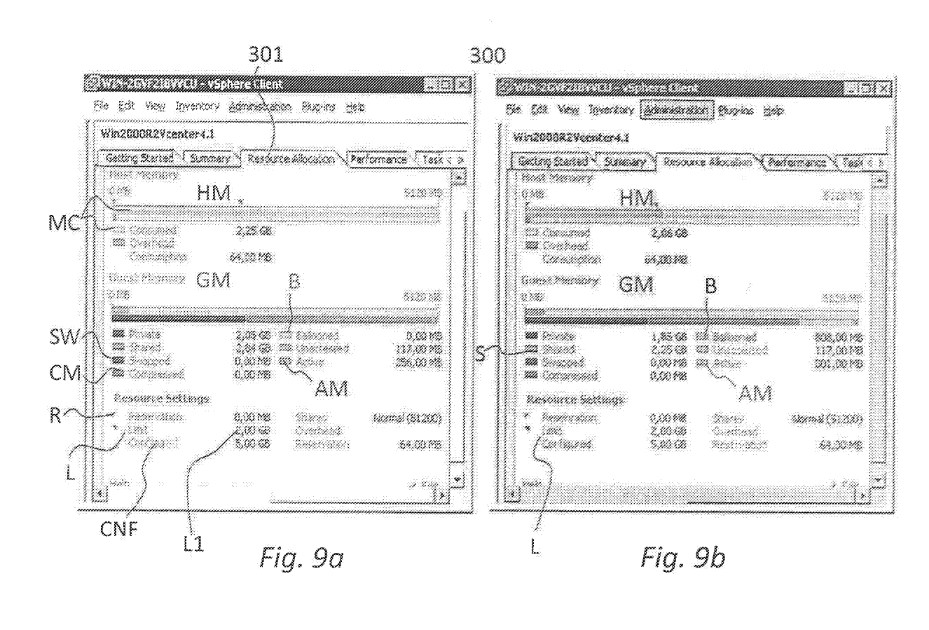

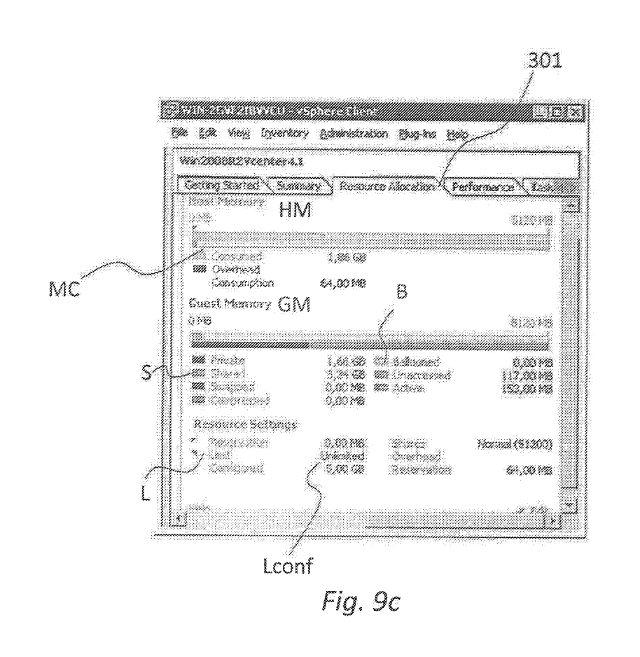

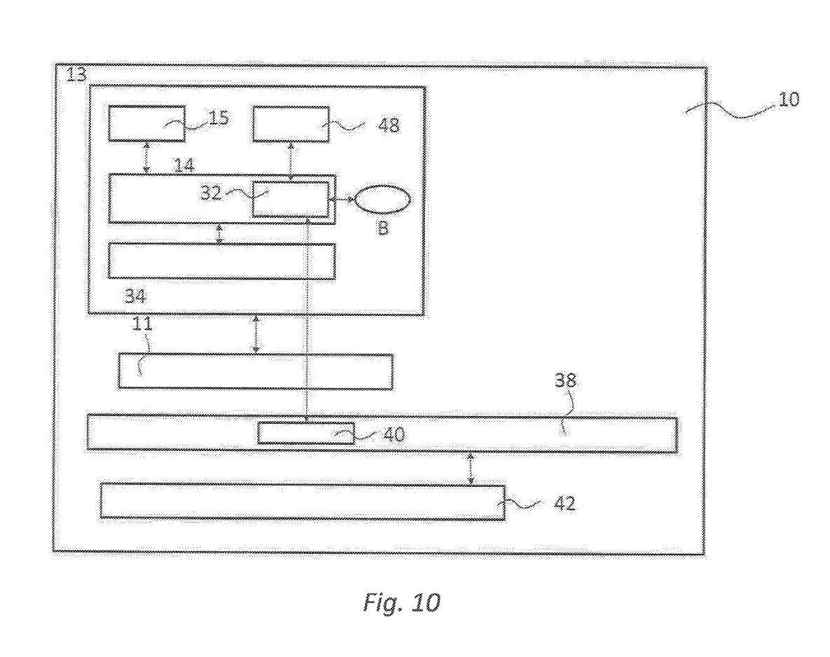

In detailing the above constraints, reference will be made to elements and quantities regarding the processes of virtualization with ballooning that are in themselves known, as well as being in part indicated in FIGS. 9a-9c and described in detail in the document at the URL http://www.vmware.com/files/pdf/perf-vsphere-memory management.pdf.

Among the static constraints or static conditions CS, as specified hereinafter, there may be listed the following:

the balloon driver must be installed;

a limit for the consumed memory MC must be higher than the value referred to as “reservation” R, i.e., the minimum amount of memory for each virtual machine, indicated in the virtualization system;

the option “Reserve all guest memory” (All Locked) must not be selected; in fact, this option maintains the memory reserve equal to the memory reserve R of the virtual machines;

an active memory AM, i.e., the amount of guest memory that is currently being used by the guest operating system 14 and by the applications 15, must be less than a given value, in particular 5%, of a memory CNF configured on the virtual machine 13;

the consumed memory MC minus the target size B of the memory balloon (indicated in FIG. 9a) must be greater than 40% of the configured memory CNF;

there must be no other ballooning procedure in progress.

Amongst the dynamic constraints or dynamic conditions CD, as specified hereinafter, there may be listed the following:

the given virtual machine 13, i.e., the one selected, must be active, i.e., “On”;

a current swapped memory SW must always be less than the initial swapped memory (if an amount of initial swapped memory was indeed present);

a current compressed memory CM must always be less than the initial compressed memory (if an amount of initial compressed memory was indeed present);

the active memory AM can increase only within given limits, control of these given limits is performed via linear regression of the point values;

the rate of writing on the disk must not exceed a given value, preferably 50 Kbps.

The method according to the invention recovers memory automatically on all the virtual machines 13 that present the static conditions CS listed above, until one of the dynamic conditions CD just described is violated.

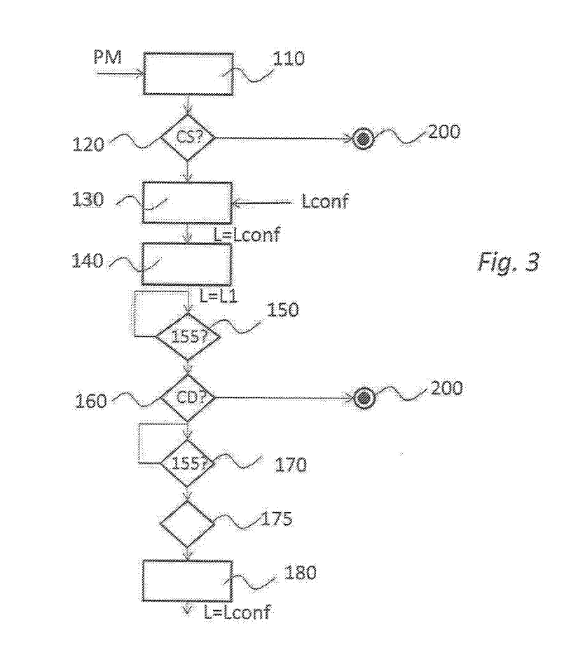

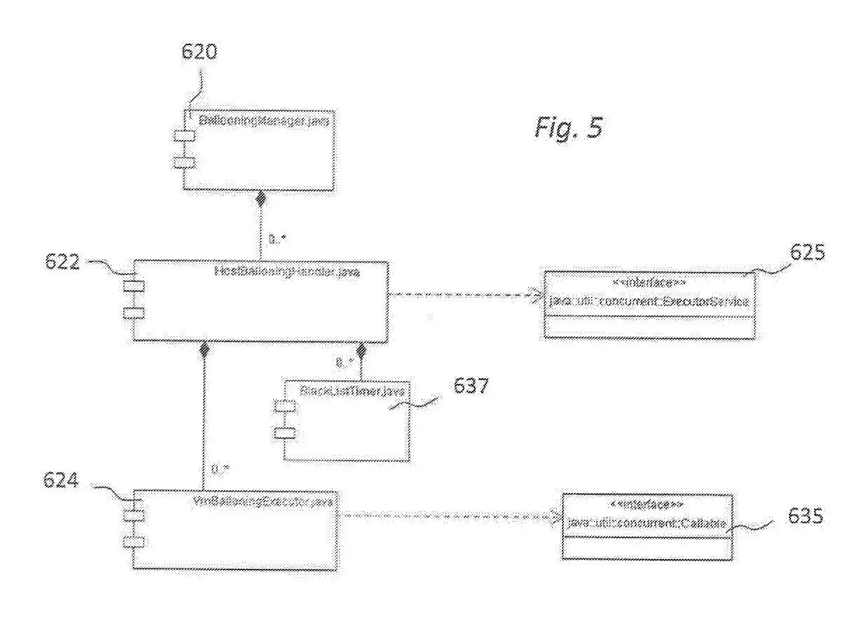

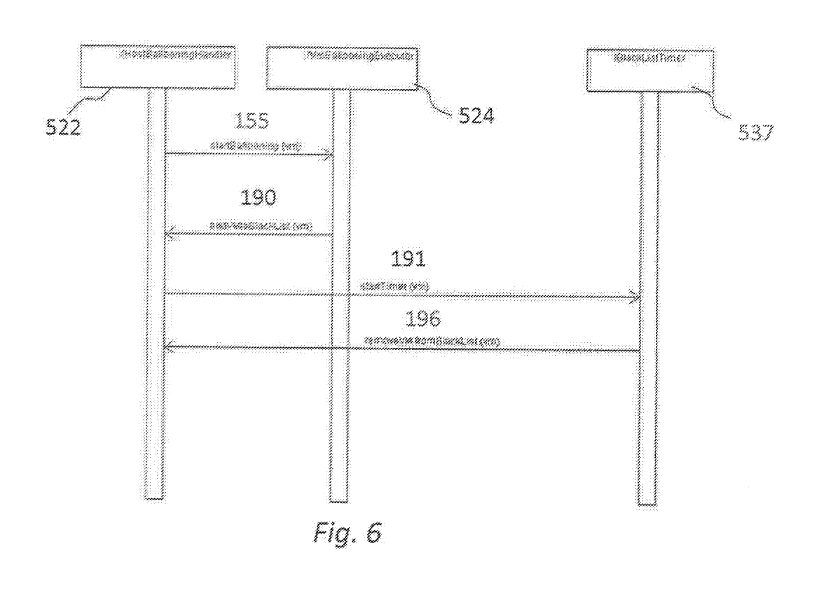

Hence, an embodiment of the method according to the invention, designated as a whole by the reference 100, is represented schematically in the general flowchart of FIG. 3 and comprises, for example, the following operations:
reading 110 the memory parameters PM of a given virtual machine 13; these memory parameters PM comprise, for example, the active memory and the configured memory;
verifying 120 the occurrence of corresponding static conditions CS;
in the case of positive outcome, carrying out a step 130 of reading of a configured limit value Lconf set by the virtual-machine monitor 11 as threshold L beyond which a ballooning operation, designated by 155 in FIG. 6, is to be carried out; otherwise, the method 100 is ended (block 200) ;
shifting 140 the threshold value L from the configured limit Lconf to a value L1, equal to a value of consumed memory MC minus a given difference Δ, preferably 5% of the value of consumed memory MC;
entering 150 a wait state until a start of ballooning operations 155 by the virtual-machine monitor 11 is detected;
checking 160 whether required dynamic conditions CD are verified by the host system; in the case of negative outcome, the method 100 is ended (block 200);
in the case of positive outcome, determining 170 when the ballooning operation 155 started by the virtual-machine monitor 11 of the virtualization system is through;
at the end of ballooning 155 (or when the dynamic conditions CD cease to arise), verifying 175 whether the consumed memory MC has dropped below the value of consumed memory MC minus a percentage PD of the given difference Δ, this percentage PD preferably being 90%;
in the case of positive outcome, setting 180 the threshold L beyond which memory allocation is to be performed again at the configured limit value Lconf; and
then putting 190 the given virtual machine 13 to which the ballooning procedure 100 has been applied in a blacklist, where it resides for a pre-set time TB, as illustrated more fully in FIG. 5 and in FIG. 6.

Hence, the method according to the invention substantially represents a method for memory management in virtual machines that comprises managing execution of ballooning operations 155 in a smart way, basically via at least the operations of reading 110 the memory parameters PM of a given virtual machine 13, reading 130 a configured limit Lconf for the consumed memory, which represents a threshold L beyond which memory allocation is to be performed, shifting 140 the aforesaid threshold L to a lower value L1, waiting 150 for start of ballooning operations by the virtual-machine monitor, checking 170 when said the ballooning operations are through, and setting 180 the threshold L beyond which memory allocation is to be performed again at the configured limit value Lconf.

It is moreover envisaged to verify occurrence of conditions of applicability for start of the procedure 100 (check on static conditions CS). It is moreover envisaged to verify conditions of applicability of the procedure 100 in progress. It is also envisaged to put the virtual machine 13 that has just undergone ballooning by shifting the threshold L from the value Lconf to L1 temporarily in a blacklist, so that the method 100 can then be applied to virtual machines 13 different from the one just treated. Furthermore, it is also envisaged, in the case of end 170 of the ballooning operations 155, an operation of verifying 175 whether the consumed memory MC has dropped below a pre-set value prior to enabling setting 180 of the threshold L beyond which allocation of memory is to be performed once again at the configured limit value Lconf.

An example of implementation of the aforesaid method for memory management in virtual machines 100 exemplified in FIG. 3 is moreover provided below using a pseudocode:

```
do {
  1. read the memory parameters of the virtual machine 13
  2. verify whether the static conditions CS exist:
```

a. If the static conditions CS exist, go to step 3; else

{
Executed=false;
go to step 9;

}

```
  3. Read the configured limit Lconf
  4. Shift the limit L to the point of value L1 (in megabytes),
```

where L1=memoryConsumed−Δ, with Δ=5% of the memory
consumed;

5. Wait until ballooning starts and check {

a. if the dynamic conditions CD do not exist, then

Executed=false

reset the limit L to Lconf and go to point 9

b. if ballooning has started go to point b

}

6. Wait for ballooning to finish and check {

a. if the consumed memory MC has dropped to MC − (PD* of

Δ), with PD=0.9, then go to point 7;

b. if the dynamic conditions CD do not exist, then

Executed =false

```
  set the limit L back again to Lconf and go to
  point 9
```

c. if ballooning is through, go to point 7;

}

```
  7. set the limit L back to Lconf and go to point 8
  8. Executed=true go to point 9
  9. while (Executed);
10. put the virtual machine 13 in the blacklist;
```

The blacklist is hence a wait queue where a virtual machine 13 is put if the ballooning procedure 100 has been applied to it. In other words, a given virtual machine 13 is entered into the blacklist because the method according to the invention 100 has gone through successfully thereon or because the method has been interrupted owing to the fact that one of the dynamic conditions CD is no longer satisfied.

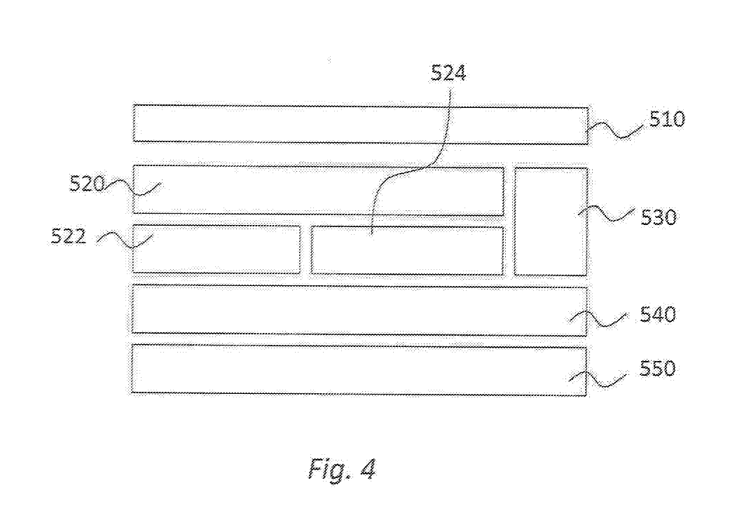

Illustrated in FIG. 4 is a diagram representing the architecture of the software that implements the method according to the invention, with a representation in layers of abstraction.

Designated by 510 is a layer corresponding to a user interface. Through this the modules or objects that implement the method according to the invention 100 are accessed. In particular, designated by 520 is an object for managing ballooning, or BallooningManager, coming under which are an object for handling the host for ballooning, or HostHandler, 522 and an object for executing ballooning, or BallooningExecutor, 524. Designated moreover by 530 are other clients accessible via the user interface 510.

Designated, instead, by 540 is the API (Application Programming Interface) of the application that implements the method according to the invention 100. The API is operatively set between the aforesaid objects 520, 522, 524 and an API 550 of the virtualization application, in particular VMware.

Implementation of the method according to the invention 100 hence envisages provision of three main objects:

BallooningManager 520;

HostHandler 522; and

BallooningExecutor 524.

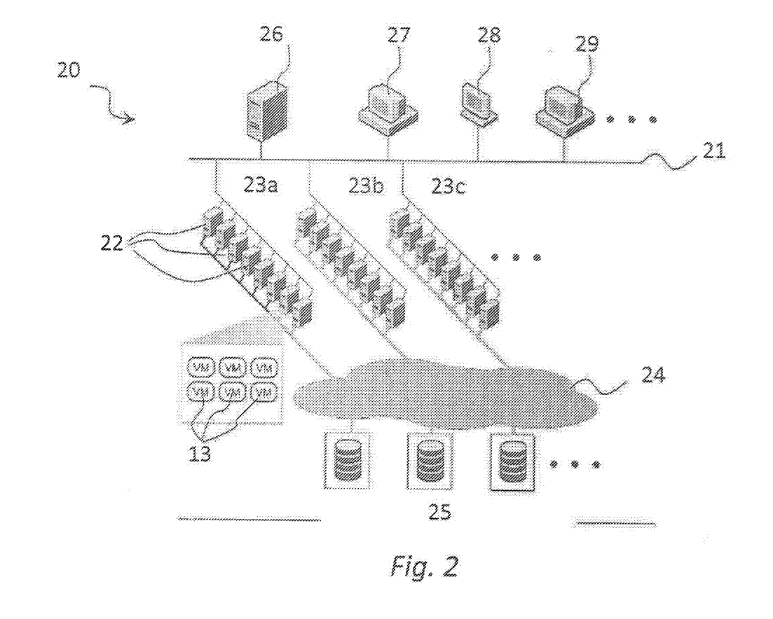

The object BallooningManager 520 is configured for managing the ballooning procedure over the entire data centres, i.e., the data centre to which the servers are connected, designated by 20 in FIG. 2. It in fact receives the requests that come from the user interface 510 or from other possible clients 530 and instantiates the object HostHandler 522. The object HostHandler 522 is configured for taking into account the method 100 with smart ballooning over an entire host of the data centre. Once the object HostHandler 522 has received the request from the object BallooningManager 520, it instantiates an object BallooningExecutor 524, which is the object that effectively implements the most important steps of the method 100 and executes them on a virtual machine implemented via the virtualization application, 540, in particular the VMware application.

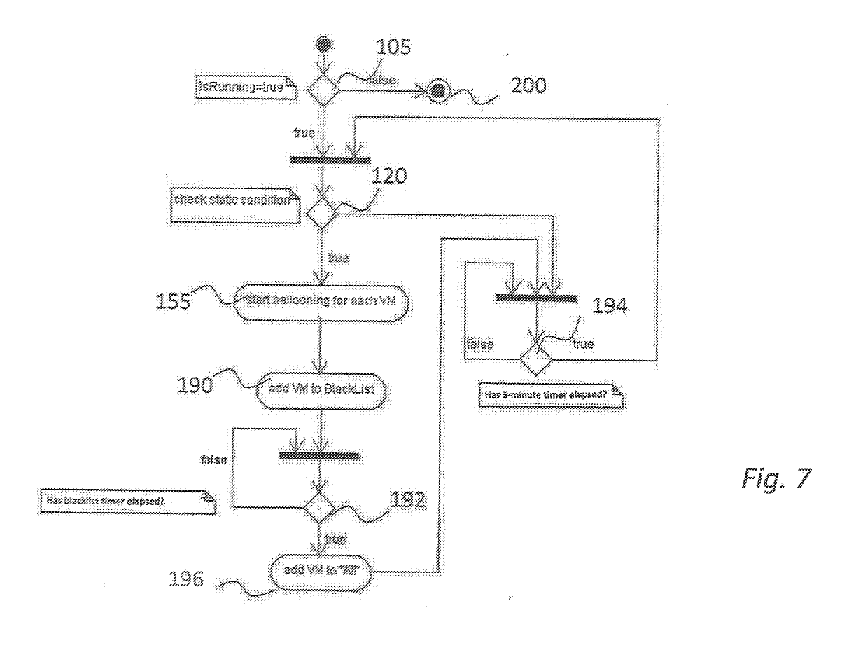

It is here pointed out that the object BallooningManager 520 operates for executing the method 100 with smart ballooning on all the hosts with virtual machines that it identifies as being on (for example, via the step 105 described more fully hereinafter, with reference to FIG. 7), but operates according to a decreasing order of size of configured memory in such a way as to recover memory immediately from the statistically most loaded virtual machines.

The foregoing will be treated in greater detail in what follows with reference to UML (Unified Modelling Language) diagrams.

FIG. 5 hence represents a diagram of the classes correlated to implementation of the procedure 100 under Java.

Designated in particular by 620 is the class BallooningManager.java corresponding to the object BallooningManager 520, by 622 is the class Hosthandler.java corresponding to the object HostHandler 522, associated to which are a respective interface 625 and a class BlacklistTimer 637 regarding an object BlacklistTimer 537, which calculates the pre-set time TB for the operation 190, and by 624 is the class BallooningExecutor.java corresponding to the object BallooningExecutor 524, associated to which is a respective interface 635.

Illustrated in FIG. 6 is a sequence diagram, which represents the sequence of operations (or macro-processes) that the host 10, understood as physical machine that hosts a number of virtual machines, carries out in order to implement the method 100 with ballooning. In this diagram, there may be noted also classes involved for implementing the business logic.

Basically, the object Hosthandler 522 carries out for a specific virtual machine 13 an operation 155 of start of ballooning, following upon which the object BallooningExecutor 524 performs ballooning. At the end of these ballooning operations 155 (or upon its interruption owing to the fact that the dynamic conditions CD no longer exist) an operation 620 of entry of the virtual machine 13 into the blacklist is carried out. Then, in a step 630 a command is issued to the object BlacklistTimer 537 for start of a timer. Once the pre-set time TB, counted by the timer of the object BlacklistTimer 537, has elapsed, an operation 196 of removal of the specific virtual machine 13 from the blacklist is carried out, and control returns to the VMware object HostHandler 522.

FIG. 7 then presents a flowchart of the operations of the object HostHandler 522. Designated by 105 is a step where a check is made to verify whether a computer, in particular a server, is on, given that at run-time it could even be off.

If the computer is on, the operation 120 of check of existence of the static conditions CS is carried out. If the static conditions CS exist, the ballooning operation 155 is started for each virtual machine 13. If the static conditions CS do not exist, the object HostHandler 522 carries out a wait operation 194, calculated by a respective timer, which waits, for example for 5 minutes, and then returns to the operation 120 of check of existence of the static conditions CS.

At the end of the ballooning operations 155, the step 190 of entry of the virtual machine 13 into the blacklist is carried out. The operation 192 of verification to check whether the pre-set blacklist time TB has elapsed is then carried out. If the pre-set blacklist time TB has elapsed, the operation 196 of removal of the virtual machine 13 from the blacklist is carried out, i.e., the virtual machine is entered into a list of available virtual machines. Next, the wait operation 194 is carried out, and then control returns to the operation 120 of check of existence of the static conditions CS.

Hence, the above operations basically identify a procedure for managing, via one or more of the specific operations 105, 120, 190, 192, 194, 196, the method according to the invention over an entire host of the data centre.

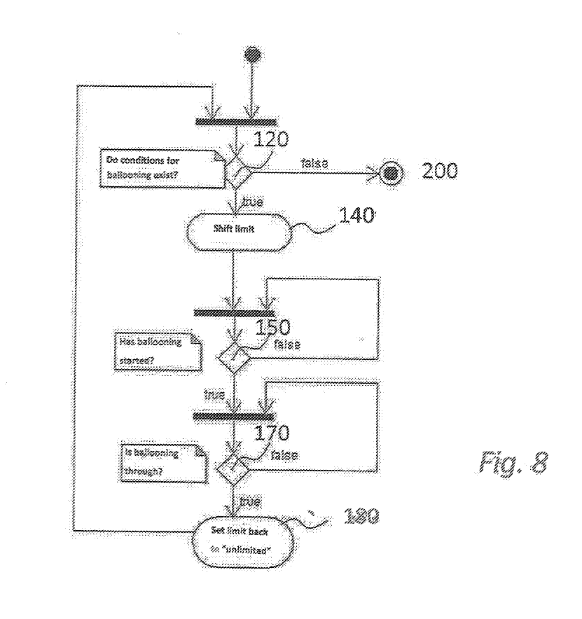

FIG. 8 then presents a flowchart of the operations of the object BallooningExecutor 524.

Initially, the object BallooningExecutor 524 carries out the operation 120 of check of existence of the static conditions CS.

If the static conditions CS exist, the operation 140 of shifting the threshold L from the configured limit Lconf to a value L1, equal to a value of consumed memory MC minus a given difference Δ, typically 5% of the value of consumed memory MC, is carried out. Hence, the threshold L is shifted from the value set (which could, for example, be an unlimited value, as indicated in FIG. 9b) to a value lower than the value of consumed memory MC.

Then, the check 150 is carried out, i.e., entry into a wait state until start of the ballooning operations 155 by the virtual-machine monitor 11 is detected.

If the ballooning operations have started, then the operation is performed of checking 170 when ballooning 155 by the virtual-machine monitor 11 has terminated.

In the case of end of the ballooning operation 155, the object BallooningExecutor 524 sets the threshold L at the original limit Lconf, which may be a pre-set value or else the unlimited value Unlimited.

Hence, these operations basically identify a procedure for carrying out the operations 140, 150, 170, which determine shifting of the threshold beyond which allocation of memory to a given virtual machine 13 is to be performed.

Hence, in this a way, by setting the value of the threshold L to a value L1 lower than the consumed memory MC, the ballooning mechanism is activated (operation 155), which produces the effects illustrated in FIGS. 9a and 9b.

In particular, appearing in FIG. 9a is a display of the interface 300 of the vSphere client, specifically of its portion or tab 301 regarding resource allocation, in a condition in which the threshold L has just been shifted from the configured limit Lconf to the lower value L1.

As may be seen, the interface 300 shows a sector dedicated to the host memory HM divided between consumed memory MC and overhead consumption, i.e., host memory used specifically for carrying out virtualization. It moreover shows a sector dedicated to the guest memory GM, i.e., the memory of the guest operating system 14, which is divided into private memory MP, shared memory S, swapped memory SW, compressed memory CMP, ballooned memory B, unaccessed memory, and active memory AM. Moreover indicated are the value of the memory reserve R, the threshold L beyond which the ballooning operation 155 is to be carried out, and the configured memory CNF.

Represented, instead, in FIG. 9b is the interface 300 in a condition where the limit L has been shifted to the lower value L1 just a few minutes before.

Represented in FIG. 9c is the interface 300 in a condition where the ballooning operation 155 has terminated. It may be seen how, when the consumed memory MC reaches the lower value L1 imposed by the threshold L, the limit itself is removed (operation 196 of FIG. 8), i.e., its value is set as “Unlimited”. The method according to the invention performs these operations automatically, waiting for the amount of balloon memory B to be converted into shared memory S by the virtual-machine monitor 11, which entails waiting for a few minutes. The threshold value L is again set (operation 140) to a value L1 lower than the consumed memory MC, for carrying out another memory-recovery cycle. In general, at each cycle only 5% of the configured memory of the virtual machine is recovered so as to prevent any stress on the virtual machine itself.

At the end of the memory-recovery cycles, the situation is the one represented by the interface 300 in FIG. 9c.

Provided in Table 1 below are the results of a test conducted on twenty servers, similar to the server 22 of FIG. 2, on which the virtualization platform VMware vSphere is being executed. Appearing in Table 1 are the names of the servers, their hardware configuration, i.e., parameters regarding the type of CPU Core, the CPU frequency, and the RAM of each server, the percentages of use of the CPU and of the RAM of the servers being tested. Appearing in the last row of Table 1 are the total of the number of cores, the average operating frequency of the servers, the total RAM of the ensemble of servers, the duty cycle of the CPU, and the duty cycle of the memory.

TABLE 1

| | CPU | CPU | | CPU | Mem. |
|---|---|---|---|---|---|
| | Core | freq. | Memory | Use | Use |
| Name | # | GHz | GByte | % | % |
| tsfvmsvpwe02svi.tsf.local | 12 | 2.9 | 96 | 9.1 | 84.7 |
| tsfvmsvpwe03svi.tsf.local | 12 | 2.9 | 96 | 24.5 | 74.2 |
| tsfvmsvpwe04svi.tsf.local | 12 | 2.9 | 96 | 23.9 | 83.0 |
| tsfvmsvpwe05svi.tsf.local | 12 | 3.0 | 192 | 11.9 | 82.8 |
| tsfvmsvpwe06svi.tsf.local | 12 | 3.0 | 192 | 12.3 | 70.9 |
| tsfvmsvpwe07svi.tsf.local | 12 | 3.0 | 192 | 30.8 | 82.1 |
| tsfvmsvpwe01svi.tsf.local | 8 | 2.9 | 96 | 5.8 | 73.6 |
| tsfvmsvpwe08svi.tsf.local | 12 | 3.0 | 192 | 28.4 | 70.8 |
| tsfvmsvpwe09svi.tsf.local | 12 | 3.0 | 192 | 11.5 | 80.9 |
| tsfvmsvpwe20svi.tsf.local | 12 | 2.9 | 96 | 37.8 | 85.6 |
| tsfvmsvpwe10svi.tsf.local | 12 | 3.0 | 192 | 26.4 | 70.4 |
| tsfvmsvpwe11svi.tsf.local | 12 | 3.0 | 192 | 40.2 | 92.8 |
| tsfvmsvpwe19svi.tsf.local | 12 | 2.9 | 96 | 4.9 | 52.5 |
| tsfvmsvpwe12svi.tsf.local | 12 | 3.0 | 192 | 46.3 | 81.7 |
| tsfvmsvpwe13svi.tsf.local | 12 | 3.0 | 192 | 44.5 | 71.3 |
| tsfvmsvpwe18svi.tsf.local | 8 | 2.9 | 96 | 9.7 | 86.2 |
| tsfvmsvpwe14svi.tsf.local | 12 | 3.0 | 192 | 16.5 | 67.3 |
| tsfvmsvpwe15svi.tsf.local | 12 | 2.9 | 96 | 26.3 | 85.4 |
| tsfvmsvpwe17svi.tsf.local | 8 | 2.9 | 96 | 31.1 | 83.9 |
| tsfvmsvpwe16svi.tsf.local | 8 | 2.9 | 96 | 5.7 | 75.1 |
| Research and Development | Total | Mean | Total | DC | DC |
| Farm | Core | freq. | RAM | CPU | Mem. |
| | 224 | 2.95 | 2880 | % | % |
| | | | | 23.1 | 77.5 |

As may be seen, the servers 520 hosted virtual machines to which a number of virtual cores ranging from 1 to 6 and a proportional amount of RAM that ranged from 1 GB to 24 GB were assigned.

The software implementing the method according to the invention was installed on a computer, from which a software vCenter VMware entrusted with management of the twenty servers was accessible. Once the credentials for access to the vCenter were entered, as first operation a list of the so-called “candidate virtual machines” was created. This list was obtained by filtering the 520 virtual machines present in the data centre through the static conditions CS described previously. The result of this test highlighted that 199 out of 520 virtual machines (i.e., 38.3%) presented the static conditions CS necessary for application of the method according to the invention.

At the end of this first configuration and verification step, the method according to the invention was activated over the entire data centre and for the duration of the test (8 hours). Throughout the duration of the test the following conditions were guaranteed:

interruption of the procedure on the virtual machines that presented signs of suffering in terms of performance;

application of the method according to the invention at the most on three virtual machines at a time in order to guarantee a negligible overhead over the entire data centre; and

creation of a “Scheduled Task” in the centre VMware vCenter to set in a programmed way the threshold value of the memory MC consumed by the virtual machine back to the original value Lconf, the purpose being to prevent any spurious configurations from being left on the memory of the virtual machines upon occurrence of any unexpected event.

The duration of the test was 8 hours during the working timetable, and during this period 57 of the 520 virtual machines (i.e., 11%) were subjected to memory recovery. From these virtual machines variable amounts of RAM that had been assigned but not used were recovered, from a minimum of 55 MB to a maximum 14 GB, for a total of 82 GB. With respect to the total amount of RAM used by the virtual machines being tested (i.e., 2287 GB), 3.6% of RAM was thus freed.

Hence, there emerges clearly the capacity of the method according to the invention to recover advantageously memory assigned but not used by the virtual machines, without causing any degradation of the quality of the service perceived by the end user. The absolute value of the RAM freed is of course linked to the duration of execution of the method according to the invention.

The method according to the invention moreover advantageously envisages, by checking static conditions, verification of its own applicability at the start, and, by checking dynamic conditions, verification of its own sustainability during execution, thus preventing the risk of incurring in errors.

The method according to the invention moreover advantageously, via the blacklist mechanism, acts in such a way that a virtual machine from which memory has been reclaimed will no longer be called upon for a given time.

Of course, without prejudice to the principle of the invention, the details and embodiments may vary even significantly with respect to what has been described herein purely by way of example, without thereby departing from the sphere of protection of the present invention, the sphere of protection being defined by the annexed claims.

The method described is in general suited to implementation in all the virtualization platforms that envisage a ballooning mechanism, which comprises allocating the memory balloon of a guest operating system to the aforesaid virtual machines with a given target size, the target size of the balloon being controlled as a function of the amount of memory of a host consumed by the virtual machines. For instance, the method can be implemented in the Linux virtualization infrastructure Kernel-based Virtual Machine (KVM).

1. A method for memory management in virtual machines comprising:
providing, in a virtual-machine monitor of a virtualization platform operating on one or more host computers, a memory-management procedure that includes ballooning operations, which comprise allocating in a guest operating system of said virtual machines guest balloon memory modules of variable memory size, which have a given target size, said target size of the guest balloon memory modules being controlled as a function of the amount of host memory consumed by the virtual machines,
reading memory parameters of a given virtual machine;
reading a value of a configured limit, set in the virtual-machine monitor, for the consumed memory, which represents a threshold beyond which allocation of memory to the guest balloon memory module is to be performed;
shifting the threshold value from said configured limit to a lower value equal to a value of the amount of consumed memory minus a given difference;
waiting for start of ballooning operations by the virtual-machine monitor;
checking when said ballooning operations terminate; and
setting the threshold beyond which allocation of memory is to be performed back again to the configured limit value.

2. The method according to claim 1, wherein the given virtual machine is to be entered into a blacklist, where it resides for a pre-set time.

3. The method according to claim 1, wherein said operations of reading the memory parameters of a given virtual machine and of shifting said threshold are carried out if occurrence of given static conditions necessary for applicability of said operation of shifting said configured limit is verified.

4. The method according to claim 1, wherein said static conditions comprise one or more of the following:
the balloon driver is installed;
the option Reserve all guest memory (All Locked) is not selected;
a limit for the consumed memory is greater than the value of minimum memory reserve for each virtual machine;
the active memory is smaller than a given value;
the consumed memory minus the target size of the balloon module is greater than 40% of the configured memory; and
no other ballooning procedure is in progress.

5. The method according to claim 1, further comprising checking, following upon start of the ballooning operations, that required dynamic conditions remain verified.

6. The method according to claim 5, wherein if the dynamic conditions are verified, said operation is carried out of checking when ballooning of the virtualization system terminates and of verifying whether the consumed memory has dropped below a value of consumed memory minus a given percentage of said given difference, even when said dynamic conditions cease to exist.

7. The method according to claim 5, wherein said dynamic conditions comprise one or more of the following:
the given virtual machine is active;
the current swapped memory is less than the initial swapped memory;
the current compressed memory is less than the initial compressed memory;
the active memory is below a given limit; and
the rate of writing on the disk does not exceed a given value.

8. The method according to claim 1, further comprising, in the case of end of the ballooning operation, verifying whether the consumed memory has dropped below a value of consumed memory minus a given percentage of said given difference and, only if this is so, setting the threshold beyond which allocation of memory is to be performed back again to the configured limit value.

9. The method according to claim 1, wherein said percentage is 90%.

10. The method according to claim 1, further comprising a ballooning-manager software module configured for managing the method over a data centre to which hosts are connected, receiving virtualization requests and instantiating a host-handler module configured for handling the method over an entire host of the data centre and for instantiating a ballooning-executor software module that is configured for carrying out the operations of shift of the threshold beyond which allocation of memory is to be performed for a given virtual machine.

11. The method according to claim 1, wherein said ballooning-manager software module operates according to a decreasing order of configured memory.

12. A computer system comprising one or more computers and a virtualization platform installed in said computer system, configured for providing, in a virtual-machine monitor, a procedure for memory management with the ballooning operations, said system being characterized in that it implements a method according to claim 1.

13. A computer program product that can be loaded into the memory of at least one computer, said computer program product comprising portions of software code for implementing the method according to claim 1 when it is run on said at least one computer.
